(19) United States
(12) Patent Application Publication
(10) Pub. No.: US 2011/0012556 A1
(43) Pub. Date: Jan. 20, 2011

(54) Wireless Chargeable Game Device

(76) Inventor: Yicheng LAI, Taoyuan City (TW)

Correspondence Address: Jackson Intellectual Property Group PLLC, 106 Starvale Lane, Shipman, VA, 22971, US

(21) Appl. No.: 12/565,835

(22) Filed: Sep. 24, 2009

(30) Foreign Application Priority Data
Jul. 16, 2009 (CN) 200920133669.2

(51) Int. Cl. H02J 7/00

(52) U.S. Cl. 320/108

(57) ABSTRACT

A wireless chargeable game device of the present invention comprises a body and a charging device. A transmitting circuit of wireless charging is provided in a case of the charging device, and a receiving circuit of wireless charging is provided in a case of the body. While charging, the transmitting circuit of the charging device is connected to the receiving circuit of the body by electromagnetic coupling. The wireless chargeable game device of the present invention is charged wireless to make the charging process easy and convenient thereby improving the entertainment experience of people using the game device, and making the charging structure completely waterproof and dustproof to improve the service life. A series resonant circuit is driven by a fixed frequency generated by a single chip microcomputer for saving a frequency adjustment circuit so as to simplify the circuit and save the cost. (FIG. 1)

### FIELD OF THE INVENTION

The present invention relates to a game device, particularly relates to a wireless chargeable game device.

### BACKGROUND OF THE INVENTION

In people's entertainment life, all kinds of game devices driven by electric power are often used. For example, the current popular game consoles such as XBOX360, PS3, and Wii, are all provided with remote control handles driven by electric power. Bodies and remote control handles of various remote control game devices need to be driven by electric power. In view of playfulness, these game devices all use batteries as the power supply. In view of convenience, economy, and environmental protection, people usually choose rechargeable batteries as the power supply.

When the rechargeable battery in a game device runs out, a contact type charger is usually used to charge the rechargeable battery by connecting the poles of the rechargeable battery to the metal contact pins of the contact type charger. However, a contact type charger is not able to be completely waterproof and dustproof. So, the exposed metal contact pins will be worn out after being used for a long time, or will be corroded and oxidized by the air, whereby poor contact will often occur between the poles and the metal contact pins. Therefore, the rechargeable battery may not be charged fully. The contact point between the poles and the metal contact pins will emit heat because of carbonification, which results in the waste of electric current. The exposed metal contact pins also are in danger of short circuit. Being limited by the charging type of the contact type charger, the entertainment experience of people using a game device will get an adverse effect. Therefore, it needs to be improved.

### SUMMARY OF THE INVENTION

To solve the above mentioned problems, an object of the present invention is to provide a wireless chargeable game device which is charged wireless without the problems of poor contact or short circuit, and facilitates to waterproof and dustproof.

To achieve the above object, a wireless chargeable game device of the present invention comprises a body and a charging device. A transmitting circuit of wireless charging is provided in a case of the charging device, and a receiving circuit of wireless charging is provided in a case of the body. While charging, the transmitting circuit of the charging device is connected to the receiving circuit of the body by electromagnetic coupling.

Wherein, the transmitting circuit comprises a main control circuit, a fixed frequency output circuit, a drive circuit, a series resonant circuit, a secondary signal detection circuit, and a current detection protection circuit; the main control circuit, the fixed frequency output circuit, the drive circuit, and the series resonant circuit are connected in turn; the main control circuit controls the electric energy to be transmitted by wireless transmitting; the secondary signal detection circuit is separately connected to the series resonant circuit and the main control circuit to detect a secondary signal; the current detection protection circuit is separately connected to the series resonant circuit and the main control circuit for current detection protection.

Wherein, the receiving circuit comprises an induction coil circuit, a bridge rectifier circuit, a switching circuit, a charging management circuit, and a rechargeable battery; the induction coil circuit, the bridge rectifier circuit, the switching circuit, and the rechargeable battery are connected in turn, so as to receive the electric energy and charge the rechargeable battery; the charging management circuit is separately connected to the bridge rectifier circuit, the switching circuit, and the rechargeable battery to manage the charging process.

Wherein, the series resonant circuit is composed of a first capacitance and a first inductance being connected in series.

Wherein, the drive circuit is composed of a NOT gate, a PMOS, and a NMOS; the PMOS and the NMOS are separately connected to the series resonant circuit to implement charging or discharging the series resonant circuit; the NOT gate is connected to the gate of the PMOS and the NMOS, so as to control the PMOS and the NMOS to be on or off.

Wherein, the main control circuit is a first single chip microcomputer.

Wherein, the fixed frequency output circuit is a second single chip microcomputer that outputs a fixed frequency.

Wherein, the charging management circuit is a third single chip microcomputer.

Wherein, the induction coil circuit is composed of a second capacitance and a second inductance being connected by parallel connection.

Wherein, the cases of the game device and the charging device are separately provided with alignment structures matching each other to align a series resonant circuit of the transmitting circuit and an induction coil circuit of the receiving circuit; while charging, the game device and the charging device are located according to the alignment structures to make the series resonant circuit to be exactly coupled to the induction coil circuit.

The main control circuit is connected to the fixed frequency output circuit, so as to control the fixed frequency output circuit to output a fixed frequency. The drive circuit is connected to the fixed frequency output circuit and the series resonant circuit, so as to transmit the frequency outputted by the fixed frequency output circuit to the series resonant circuit, and then the series resonant circuit is driven. The bridge rectifier circuit is composed of four diodes being connected as a bridge rectifier; the bridge rectifier circuit is connected to the induction coil circuit, so as to convert the alternating voltage generated by the induction coil circuit to a DC voltage. The bridge rectifier circuit is also connected to the switching circuit and the charging management circuit, so as to provide a working voltage to the charging management circuit, and provide a charge voltage to the rechargeable battery via the switching circuit.

In summary, the wireless chargeable game device of the present invention is charged wireless to make the charging process easy and convenient, thereby improving the entertainment experience of people using the game device, and making the charging structure completely waterproof and dustproof to improve the service life. Since the series resonant circuit is driven by a fixed frequency generated by a single chip microcomputer, a voltage that is stable in a certain range can be generated at the two terminals of the inductance through providing the series resonant circuit with the values of the inductance and the capacitance in a certain range whereby a frequency adjustment circuit is saved, so as to simplify the circuit and save the cost.

The characteristic and the technical solution of the present invention are best understood from the following detailed description with reference to the accompanying figures, but the figures are only for reference and explaining, not to limit the scope of the invention.

### BRIEF DESCRIPTION OF THE DRAWINGS

The technical solution and the beneficial effects of the present invention are best understood from the following detailed description with reference to the accompanying figures and embodiments.

FIG. 1 is a schematic diagram showing the charging principle of a wireless chargeable game device of the present invention;

FIG. 2 is a circuit diagram showing the wireless chargeable game device in accordance with an embodiment of the present invention;

FIG. 3 is a perspective view of the wireless chargeable game device in accordance with an embodiment of the present invention.

### DESCRIPTION OF THE PREFERRED EMBODIMENT

To further set forth the technical solution adopted by the present invention and the effect, the present invention is described detailedly with reference to the preferred embodiments and the accompanying figures.

A wireless chargeable game device of the present invention comprises a body and a charging device. A transmitting circuit of wireless charging is provided in a case of the charging device, and a receiving circuit of wireless charging is provided in a case of the body. While charging, the transmitting circuit of the charging device is connected to the receiving circuit of the body by electromagnetic coupling.

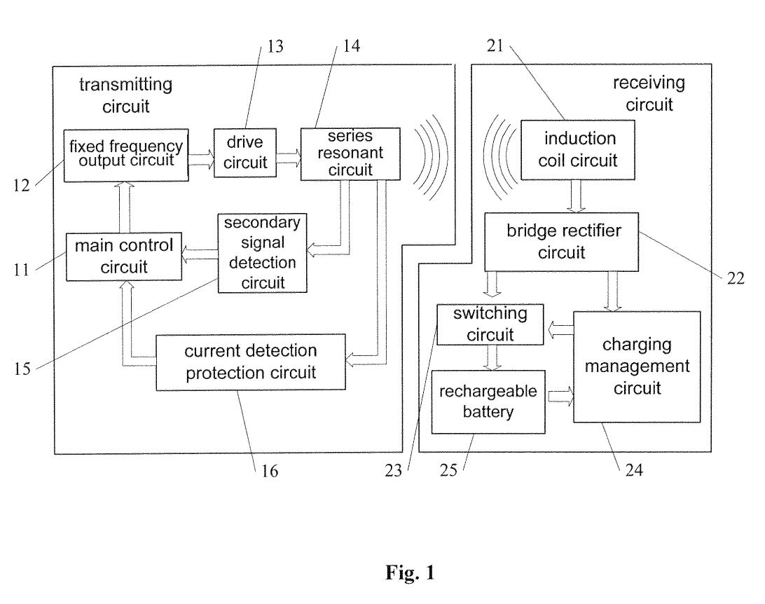

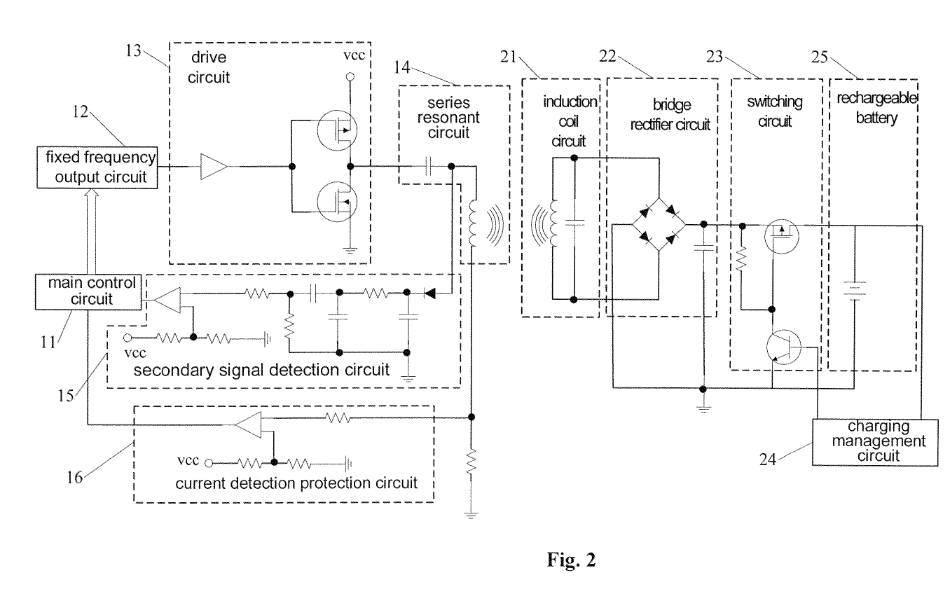

Referring to FIG. 1 and FIG. 2, the transmitting circuit comprises a main control circuit 11, a fixed frequency output circuit 12, a drive circuit 13, a series resonant circuit 14, a secondary signal detection circuit 15, and a current detection protection circuit 16. The main control circuit 11, the fixed frequency output circuit 12, the drive circuit 13, and the series resonant circuit 14 are connected in turn. The main control circuit 11 controls the electric energy to be transmitted by wireless transmitting. The secondary signal detection circuit 15 is separately connected to the series resonant circuit 14 and the main control is circuit 11 to detect a secondary signal. The current detection protection circuit 16 is separately connected to the series resonant circuit 14 and the main control circuit 11 for current detection protection.

The receiving circuit comprises an induction coil circuit 21, a bridge rectifier circuit 22, a switching circuit 23, a charging management circuit 24, and a rechargeable battery 25. The induction coil circuit 21, the bridge rectifier circuit 22, the switching circuit 23, and the rechargeable battery 25 are connected in turn, so as to receive the electric energy and charge the rechargeable battery 25. The charging management circuit 24 is separately connected to the bridge rectifier circuit 22, the switching circuit 23, and the rechargeable battery 25 to manage the charging process.

The series resonant circuit 14 is composed of a first capacitance and a first inductance being connected in series. When an appropriate frequency is applied to the series resonant circuit 14, an alternating voltage which is several times of the power supply is generated at the two terminals of the first capacitance and the first inductance for transmitting the energy out. The drive circuit 13 is composed of a NOT gate, a PMOS (P-channel metal oxide semiconductor), and a NMOS (N-channel metal oxide semiconductor). The PMOS and the NMOS are separately connected to the series resonant circuit 14 to implement charging or discharging the series resonant circuit 14, so as to build the resonant circuit. The NOT gate is connected to the gate of the PMOS and the NMOS, so as to make the PMOS and the NMOS to be on or off. The induction coil circuit 21 is composed of a second capacitance and a second inductance being connected by parallel connection. The bridge rectifier circuit 22 is composed of four diodes.

The main control circuit 11 is a first single chip microcomputer. After the transmitting circuit is energized, the fixed frequency output circuit 12 is started to output a fixed frequency signal at intervals. At the same time, the first single chip microcomputer detects whether the receiving circuit exists or not. If the receiving circuit exists, the receiving circuit is charged with the first single chip microcomputer controlling the fixed frequency output circuit 12 to output the frequency for a long time to transmit the energy for a long time, so as to charge rapidly. The charging status can be indicated by LEDs. The first single chip microcomputer can also do over-current detection in the circuit, which can also be indicated by LEDs. The fixed frequency output circuit 12 is composed of a second single chip microcomputer. The second single chip microcomputer is used to output a fixed frequency. The main control circuit 11 controls the second single chip microcomputer to output a frequency or not. So, the frequency is stable, and is easy to control.

The frequency generated by the fixed frequency output circuit 12 flows through the drive circuit 13 to enable the series resonant circuit 14 to be started in high efficiency. After started, a comparatively high alternating voltage is generated at the two terminals of the first inductance to form an electromagnetic field. When the induction coil circuit 21 is approached, the induction coil circuit 21 starts to charge the chargeable battery 25. At the moment of charging, the voltage at the two terminals of the second inductance is changed, and the changing voltage will be induced back to the series resonant circuit 14. So, the secondary signal detection circuit 15 gets the secondary signal and then feed it back to the main control circuit 11. Accordingly, the information, such as whether the receiving circuit is charged or not, or whether the charging is finished or not, can be known, and then can be indicated by LEDs. If a problem occurs in the series resonant circuit 14, for example, the current is too high, the current detection protection circuit 16 feeds the signal back to the main control circuit 11, and the main control circuit 11 will stop the fixed frequency output circuit 12 to output the frequency. Therefore, the series resonant circuit 14 stops working thereby protecting the circuit.

The induction coil circuit 21 is composed of the second capacitance and the second inductance being connected by parallel connection. When the induction coil circuit 21 is near the series resonant circuit 14, it generates an alternating voltage. The alternating voltage is converted into a DC voltage via the bridge rectifier circuit 22. At this moment, the charging management circuit 24 starts to work, to control the switching circuit 23 to charge the rechargeable battery 25. The rechargeable battery 25 may be a conventional lithium battery or a conventional nickel-hydrogen battery. During the charging process, the induction coil circuit 21 (the secondary) continually feeds back a signal to the series resonant circuit 14 (the primary). So, the main control circuit 11 can know the charging status of the rechargeable battery 25, and the charging status can be indicated by LEDs or other ways. The switching circuit 23 is composed of a PMOS for charging the rechargeable battery 25 by pulse current charge. The pulse current is from the charging management circuit 24. The charging management circuit 24 is composed of a third single chip microcomputer for managing charging. Different charging modes will be used according to different statuses of the rechargeable battery, so as to protect the rechargeable battery best, and to increase the service life of the rechargeable battery to the utmost. If a nickel-hydrogen battery is charged, it can be determined by—ΔV (the variation of voltage) whether the nickel-hydrogen battery is charged fully. So, the nickel-hydrogen battery can get fully charged. At the same time, the nickel-hydrogen battery is protected by using the longest charging time, and poor nickel-hydrogen batteries will not be overcharged. If a lithium battery is charged, it can be determined by the voltage whether the lithium battery is charged fully, so as to make the lithium battery to be charged to the utmost.

The frequency of the transmitting circuit is generated and controlled by single chip microcomputers. Thus, the frequency is very precise and stable and the detection is also very sensitive. The current detection protection circuit 16 makes the whole circuit to work more reliably. The charging and the detection at the end of the rechargeable battery is also controlled by a single chip microcomputer. The precise voltage detection can determine the status of the rechargeable battery reliably and sensitively. Therefore, the corresponding charging mode can be implemented, and the rechargeable battery can be charged fully without the problems such as overheating or overcharging. The series resonant circuit 14 is driven by a fixed frequency. Thus, a resonant voltage which is several times of the voltage of the power supply is generated at the two terminals of the resonant inductance. By choosing the values of the inductance and the capacitance in a certain range, a voltage that is stable in a certain range can be generated at the two terminals of the inductance. Thus, a frequency adjustment circuit is saved. The frequency is generated directly by a single chip microcomputer, so as to simplify the circuit and save the cost.

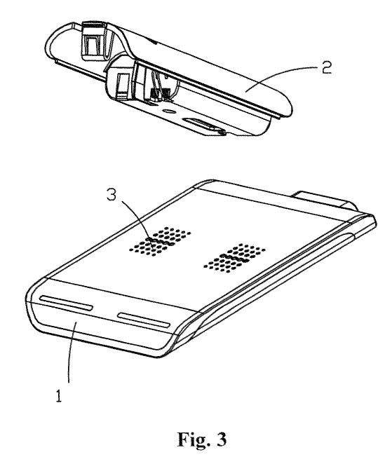

Referring to FIG. 3, a wireless chargeable game device in accordance with an embodiment of the present invention comprises a charging device 1 and a body 2. A transmitting circuit of wireless charging is provided in a case of the charging device 1. The body 2 is a remote control handle. A receiving circuit of wireless charging is provided in a case of the body 2. The charging device 1 is flat with an upper surface thereof being used to place the body 2 for charging. While charging, the transmitting circuit of the charging device 1 is connected to the receiving circuit of the body 2 by electromagnetic coupling. To increase the charging efficiency between the charging device 1 and the body 2, the charging device 1 and the body 2 are separately provided with alignment structures matching each other to align the series resonant circuit of the transmitting circuit and the induction coil circuit of the receiving circuit. While charging, the body 2 and the charging device 1 are located according to the alignment structures to make the series resonant circuit to be exactly coupled to the induction coil circuit. For example, the upper surface of the charging device 1 is provided with a sign 3 indicating the position of the series resonant circuit, and the body 2 is placed to the charging device 1 according to the sign 3, so as to make the induction coil circuit of the receiving circuit exactly face the series resonant circuit of the transmitting circuit. The alignment structure can also be in other forms to implement aligning the series resonant circuit and the induction coil circuit. For example, the body is provided with a protrusion, and the charging device is provided with a recess, so as to align them. As another example, the body can be provided with a recess, and the charging device can be provided with a protrusion. As another example, the body and the charging device can both have a step to match each other.

In summary, the wireless chargeable game device of the present invention can be charged wireless to make the charging process easy and convenient thereby improving the entertainment experience of people using the game device, and making the charging structure completely waterproof and dustproof to improve the service life of the game device. Since the series resonant circuit is driven by a fixed frequency generated by a single chip microcomputer, a voltage that is stable in a certain range can be generated at the two terminals of the inductance through providing the series resonant circuit with the values of the inductance and the capacitance in a certain range. Thus, a frequency adjustment circuit is saved in the present invention, so as to simplify the circuit and save the cost.

Although the present invention has been described in detail with above said embodiments, but it is not to limit the scope of the invention. So, all the modifications and changes according to the characteristic and spirit of the present invention, are involved in the protected scope of the invention.

What is claimed is:

1. A wireless chargeable game device comprising a body and a charging device; a transmitting circuit of wireless charging being provided in a case of the charging device, and a receiving circuit of wireless charging being provided in a case of the body; while charging, the transmitting circuit of the charging device being connected to the receiving circuit of the body by electromagnetic coupling.

2. The wireless chargeable game device of claim 1, wherein the transmitting circuit comprises a main control circuit, a fixed frequency output circuit, a drive circuit, a series resonant circuit, a secondary signal detection circuit, and a current detection protection circuit; the main control circuit, the fixed frequency output circuit, the drive circuit, and the series resonant circuit are connected in turn; the main control circuit controls the electric energy to be transmitted by wireless transmitting; the secondary signal detection circuit is separately connected to the series resonant circuit and the main control circuit to detect a secondary signal; the current detection protection circuit is separately connected to the series resonant circuit and the main control circuit for current detection protection.

3. The wireless chargeable game device of claim 1, wherein the receiving circuit comprises an induction coil circuit, a bridge rectifier circuit, a switching circuit, a charging management circuit, and a rechargeable battery; the induction coil circuit, the bridge rectifier circuit, the switching circuit, and the rechargeable battery are connected in turn, so as to receive the electric energy and charge the rechargeable battery; the charging management circuit is separately connected to the bridge rectifier circuit, the switching circuit, and the rechargeable battery to manage the charging process.

4. The wireless chargeable game device of claim 2, wherein the series resonant circuit is composed of a first capacitance and a first inductance being connected in series.

5. The wireless chargeable game device of claim 2, wherein the drive circuit is composed of a NOT gate, a PMOS, and a NMOS; the PMOS and the NMOS are separately connected to the series resonant circuit to implement charging or discharging the series resonant circuit; the NOT gate is connected to the gate of the PMOS and the NMOS, so as to control the PMOS and the NMOS to be on or off.

6. The wireless chargeable game device of claim 2, wherein the main control circuit is a first single chip microcomputer.

7. The wireless chargeable game device of claim 2, wherein the fixed frequency output circuit is a second single chip microcomputer which outputs a fixed frequency.

8. The wireless chargeable game device of claim 3, wherein the charging management circuit is a third single chip microcomputer.

9. The wireless chargeable game device of claim 3, wherein the induction coil circuit is composed of a second capacitance and a second inductance being connected by parallel connection.

10. The wireless chargeable game device of claim 1, wherein the cases of the game device and the charging device are separately provided with alignment structures matching each other to align a series resonant circuit of the transmitting circuit and an induction coil circuit of the receiving circuit; while charging, the game device and the charging device are located according to the alignment structures to make the series resonant circuit to be exactly coupled to the induction coil circuit.
